(19) United States
(12) Patent Application Publication
(10) Pub. No.: US 2021/0357918 A1
(43) Pub. Date: Nov. 18, 2021

(54) COMMERCE SYSTEMS HAVING INTEGRATED DELIVERY FEATURE

(71) Applicant: RocketFuel Blockchain, Inc., Beverly Hills, CA (US)

(72) Inventor: Joseph E. Page, La Jolla, CA (US)

(21) Appl. No.: 16/877,347

(22) Filed: May 18, 2020

(51) Int. Cl. G06Q 20/36; G06Q 30/06

(52) U.S. Cl. CPC G06Q 20/3678; G06Q 30/0641; G06Q 30/0635

(57) ABSTRACT

Commerce systems based upon cryptocurrency based payment transactions made in a peer-to-peer network include an integrated delivery feature. Consumer users using special purpose cryptocurrency wallet modules of these systems automatically encode delivery information in a payment response conveyed to an e-commerce site along with a cryptocurrency payment and transmit these respectively to the payee and peer-to-peer network for validation. Receipt of such payment responses which include user shipping information stimulate retailer shipping administrative systems into action whereby goods and services are conveyed to a customer's address in view of the successful payment made in this fashion.

### BACKGROUND OF THE INVENTION

### Field

The following invention disclosure is generally concerned with cryptocurrency commerce systems and specifically concerned with cryptocurrency based commerce systems having an integrated delivery feature to effect a ‘buy and ship’ type retail sale actions.

### Related Systems

The controversially famous Amazon ‘single-click’ invention presented in U.S. Pat. No. 5,960,411, surviving a rigorous 4 year re-examination 90/007,946 to emerge largely unscathed, remains a very powerful concept in e-commerce. The patent will remain in force until September 2017 providing Amazon a very enviable advantage in the e-commerce arena.

In brief, an Amazon® customer prepares a profile that includes credit card account details and shipping address. Thereafter, while browsing an Amazon shopping website a so-prepared customer can avoid tedious check out/shopping cart processes by using a ‘single click’ checkout. One click on the appropriate button informs Amazon of their customer's decision to buy a product; further authorizes charges to the credit card on file; and finally specifies the delivery address similarly by way of the customer's prepared profile details.

Amazon is not alone in their efforts to make shopping easy for customers with particular regard to the checkout process. EBay® has operates an instant ‘buy it now’ feature which similarly permits a customer to skip an auction bidding process and invoke an instant sale transaction. Payment and shipping details follow immediately after a website user exercises the ‘buy it now’ feature.

The PayPal component of eBay also permits storage of a delivery address whereby a known customer can avoid repeatedly entering shipping details as that information may be recalled from a profile maintained memory registers.

A new and interesting system based upon distributed cryptography includes a cryptocurrency known as ‘bitcoin’. While primarily a currency, bitcoin additionally includes many important features which are fairly characterized as entire payment transactional systems. The bitcoin peer-to-peer network has quickly risen up to become far more than mere currency. While still quite in its infancy, supporting system which integrate with the remarkable features of bitcoin come forth daily and probably will continue for some time into the future.

The original bitcoin specification permitted users to direct payment transactions towards either of two alternative destinations. These include a ‘bitcoin address’ or public key portion of an asymmetric cryptographic key pair or to an IP address. According to the protocol, if a payment transaction was directed to an IP address, the payee's computer would send a request via hypertext transfer protocol http to the specified URL which could be parsed and responded to in accordance with a rudimentary payment protocol that included generation of a new bitcoin address and conveyance of same to the payee whereafter a conventional payment transaction would be passed into the peer-to-peer network for processing normally. Sometimes referred to as a ‘pay to IP’ feature, the transaction was not used by early bitcoin adopters and this provision was finally dropped from future versions of the core protocol.

A new protocol being actively developed this even date herewith is sometimes known in the community as BIP70 or “bitcoin improvement proposal” is titled “payment protocol” with an ‘owner’ specified as Gavin Andresen presently in ‘draft’ status. This information is detailed at URL: “https://github.com/bitcoin/bips/blob/master/bip-0070.mediawiki”. A ‘snapshot’ of the state of this document on Apr. 2, 2014 is hereby incorporated by reference and included in this disclosure.

The new payment protocol follows from original ideas developed by Satoshi. However, the new protocol is more advanced and is devised with better account for security provisions.

While systems and inventions of the art are designed to achieve particular goals and objectives, some of those being no less than remarkable, these inventions of the art have nevertheless include limitations which prevent uses in new ways now possible. Inventions of the art are not used and cannot be used to realize advantages and objectives of the teachings presented herefollowing.

It should be understood that all of herein referenced materials including those set forth in appended information disclosure statement provide considerable definition with regard to elements of these inventions. Therefore, those materials are incorporated herein by reference whereby this specification can rely upon them for enablement of the particular teachings of each.

### SUMMARY OF THE INVENTION

Comes now, Jos. E. Page with inventions of cryptocurrency based commerce systems having integrated delivery and shipping feature including devices, methods and articles therefor.

It is a primary function of these commerce systems to provide an integrated delivery and shipping feature with cryptocurrency payment transaction schemes. It is a contrast to prior art inventions that systems first presented are integrated with cryptocurrency mechanisms and process. A fundamental difference between commerce systems of the instant invention and those of the art can be found when considering its relationships with established cryptocurrency networks.

Commerce systems including cryptocurrency-based retail sales systems having integrated delivery features therein are first described and presented in the disclosure herefollowing. Specifically, systems are provided in-part as commerce systems which forms payment transactions between a payor and payee in cooperation with the BIP 0070 Payment Protocol and in further cooperation with a cryptocurrency network. Upon receipt and validation of such payment transactions, retailers are in a position to respond by conveying goods and services to the addresses specified in accordance with formats set-up and prescribed by e-commerce designers. Once a consumer user initiates the cryptocurrency client or user profile portion of a wallet module with her delivery details and preferences, she is thereafter relieved of having to specify same to each retailer in the future. Rather, this information is automatically conveyed as part of the standard payment protocol described as BIP 0070—a retailer understands that receipt of such payment action with delivery information encoded therein is a customer request for automatic transmission of goods and services purchased to said address.

Customers of e-commerce retail goods and services sometimes enjoy paying for these via new cryptocurrency systems for example that which is known as the bitcoin peer-to-peer network. To make a cryptocurrency payment, one generally uses special software which aids in the formulation of the correct parameters to cause a payment from one party (buyer) to another party (seller). This software is sometimes and herein called a ‘cryptocurrency client’ or ‘wallet module’ may be arranged to support features related to conveyance of payment as well as provisions for shipping instructions.

Specifically in many instances where payment is tendered, a seller must follow with delivery of goods and/or services. In most conventional systems, a retailer must inquire as to delivery instructions—these are often provided by buyers manually. In the systems taught herein, delivery and/or shipping instructions are automatically included and integrated with payment transactions. This relieves both buyer and seller of the need to exchange this information which tends to render smooth, quick and efficient completion of sales transactions.

Of course this is particularly the case for shoppers using online commerce systems or e-commerce systems. At the end of most common online shopping cart interfaces, the system demands delivery service selection and input of a delivery address. Customers are long fatigued with having to re-enter their mailing addresses every time they make a purchase on the Internet.

Systems presented here receive on a single occasion a customer's delivery and shipping address and preferences in an initialization process taken up at a cryptocurrency wallet which maintains a user profile and thereafter automatically submits same with future payments made on the system. Payments so made are received by e-commerce retailers and their shipping administration systems may be configured to receive these addresses such that automated mailroom procedures assure delivery of goods and services are made to addresses received as part of this payment protocol.

### Objectives of the Invention

It is a primary object of these inventions to provide cryptocurrency based commerce systems.

It is an object of the invention to provide such commerce systems having integrated delivery functionality.

It is a further object to provide commerce systems cooperatively coupled to peer-to-peer cryptocurrency networks wherein said commerce systems include automated delivery features.

A better understanding can be had with reference to detailed description of preferred embodiments and with reference to appended drawings. Embodiments presented are particular ways to realize the invention and are not inclusive of all ways possible. Therefore, there may exist embodiments that do not deviate from the spirit and scope of this disclosure as set forth by appended claims, but do not appear here as specific examples. It will be appreciated that a great plurality of alternative versions are possible.

### BRIEF DESCRIPTION OF THE DRAWING FIGURES

These and other features, aspects, and advantages of the present inventions will become better understood with regard to the following description, appended claims and drawings where:

FIG. 1 is a prior art diagram illustrating how a newly proposed protocol is being engineered to support advanced cryptocurrency transactional information exchange;

FIG. 2 is an illustrative e-commerce website having active web components in conformance with the teachings presented herein; and

FIG. 3 is a block diagram of major system components and their relationships between cooperating elements.

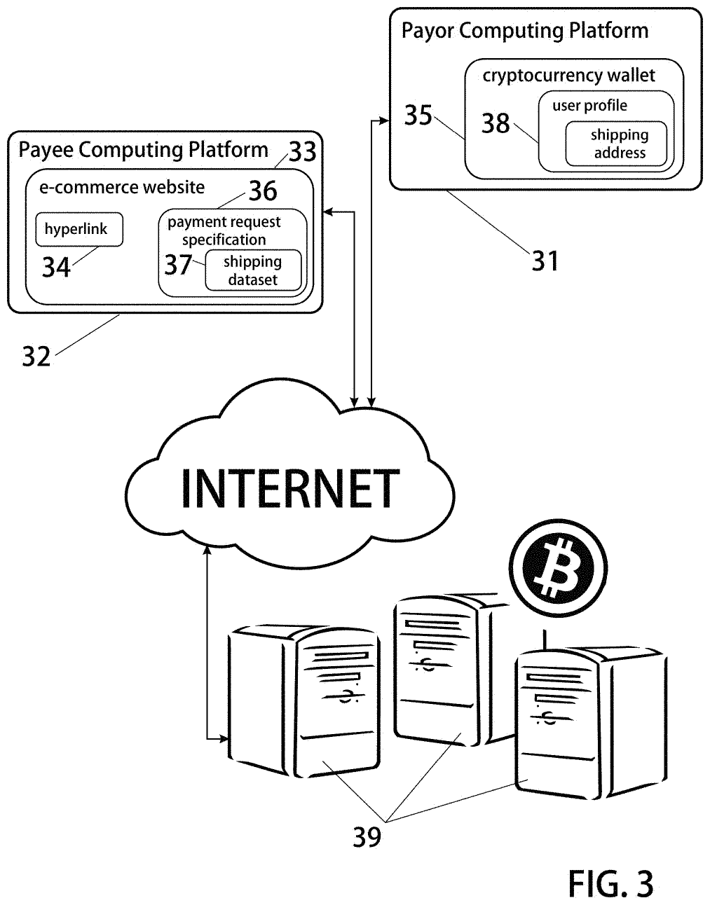

### GLOSSARY QF SPECIAL TERMS

Throughout this disclosure, reference is made to some terms which may or may not be exactly defined in popular dictionaries as they are defined here. To provide a more precise disclosure, the following term definitions are presented with a view to clarity so that the true breadth and scope may be more readily appreciated. Although every attempt is made to be precise and thorough, it is a necessary condition that not all meanings associated with each term can be completely set forth. Accordingly_{;} each term is intended to also include its common meaning which may be derived from general usage within the pertinent arts or by dictionary meaning. Where the presented definition is in conflict with a dictionary or arts definition, one must consider context of use and provide liberal discretion to arrive at an intended meaning. One will be well advised to error on the side of attaching broader meanings to terms used in order to fully appreciate the entire depth of the teaching and to understand all intended variations.

### Carrier Wave Signal

A ‘carrier wave signal’ is a physical construct embodied as an electromagnetic wave formed to carry information by way of either spatial or temporal modulation.

### Delivery or Shipping Address

‘Delivery address’ or ‘Shipping address’ is a specification of a customer's preferred location to receive goods and services. Delivery addresses may be physical addresses such as postal or mailing addresses, or may be virtual addresses such as URLs, e-mail addresses, et cetera.

### Cryptocurrency Transaction

A discrete transaction on a cryptocurrency network is specified in accordance with a protocol and this is encoded as a unitary object and is published on the network for execution there.

### DETAILED DESCRIPTION AND PREFERRED EMBODIMENTS

In accordance with each of preferred embodiments of the invention, commerce systems based upon cryptocurrency payments with integrated delivery information are provided. It will be appreciated that each of the embodiments described include an apparatus and that the apparatus of one preferred embodiment may be different than the apparatus of another embodiment. Accordingly, limitations read in one example should not be carried forward and implicitly assumed to be part of an alternative example.

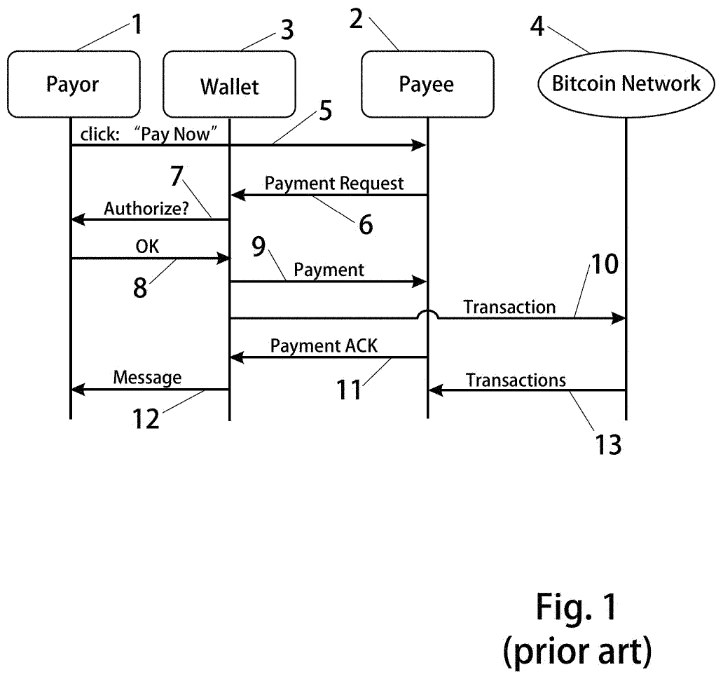

FIG. 1 illustrates in a diagram the new bitcoin BIP70 protocol which is presently in early development. A payment to be executed between a ‘payor’ 1 and a ‘payee’ 2 is encoded as electronic carrier wave signals by a wallet 2 software package or module and is transmitted towards a peer-to-peer cryptocurrency network 4, in particular the bitcoin network.

A system user in the role of payor may come into position of wanting to convey value to some recipient or payee during browsing the payee's website, for example an e-commerce type website on which certain consumer products are offered for sale.

The user may be offered a graphical user interface web object of particular nature herein and commonly known as a ‘hyperlink’ object. A hyperlink object has a graphical embodiment usually with at least a text label, some rendering information, and additionally a uniform resource locator or URI. The URI is a device which ‘points’ to some network resource. While the vast majority of typically used URIs are of the type hypertext transfer protocol “http:”, other lessor used URIs also support several other protocols such as file transfer protocol “ftp:”, simple mail transfer protocol “mailto:”, among others. One important newly emerging URI is the bitcoin URI—“bitcoin:”. This protocol is defined and set forth in detail as BIP 0021.

When using the bitcoin URI with a hyperlink web object, a website designer enables a mechanism for interaction and stimulation of a local wallet module running on a user machine. In particular, a designed portion of the e-commerce website can cause and trigger a bitcoin wallet on the user machine to launch into action, action which is dependent upon values passed into the wallet from the hyperlink URI and hence the e-commerce website. Accordingly, when a user ‘clicks’ on a hyperlink of the e-commerce site, for example a ‘pay now’ hyperlink 5, the wallet on the user machine can generate a web request action and transmit that to the payee's e-commerce server. In view of the bitcoin payment protocol defined in BIP 0070, this generally takes the form of asking for receipt of a ‘Payment Request’ specification 6.

As such, an e-commerce website in accordance with the bitcoin Payment Protocol defined in BIP 0070 suggests a hyperlink which includes a uniform resource locator URL which points to the location of the payment request specification. When a consumer user clicks on the hyperlink, the bitcoin URI tells the users wallet to take action and request from the e-commerce server the payment request specification. The wallet module then receives a response from the e-commerce server, the response includes this payment request specification.

Accordingly, an example hyperlink URI may look like this: bitcoin:1EasyUkrN1ibrG3NQ1btmZ5afc3wcFSDgD?r=http://easybitcoin.us\choo\R42r489

This example of a bitcoin uniform resource identifier includes the http uniform resource locator: “http://easybitcoin.us\choo\R42r489” which points to the e-commerce server where the payment request specification lies. Web requests directed to this address are met with a response which is the transmission of the payment request specification to the requesting party.

A ‘Payment Request’ specification defines all information elements required by the server to correctly process a payment request. It is entirely up to the e-commerce website designer to determine which information elements are needed. Therefore, a first e-commerce website might have a Payment Request specification which is different from the Payment Request specification used by a different e-commerce site. The details of each Payment Request specification are depend upon the needs of the e-commerce site.

A Payment Request specification is merely a data body characterized as a serializing data structure. A serializing data structure may come in various forms but several of these forms are becoming dominate in their adoption. For example, while XML provides an excellent framework for serializing and defining a data structure, it is sometimes cumbersome where brevity is preferred. In these cases, ‘protocol buffers’ promoted by Google are preferred. Either way, this serializing data structure tells the user wallet module which data elements are needed and which form (data type) these data elements should be presented. With this information, the wallet can carefully construct the payment information required by this particular e-commerce site. Each e-commerce site may have its own Payment Request definitions and the wallet is responsible for parsing these and providing the appropriate payment response to the requesting website,

After the wallet receives, parses and validates the Payment Request from the e-commerce site, the wallet asks the user for authorization 7 to continue processing a payment. A user indicates final agreement 8 ‘OK’ to cause the wallet to generate a ‘Payment’ action 9. This Payment action is transmitted to the Payee and includes all information requested in the Payment Request in the correct format for which the e-commerce site demands.

In addition, the wallet at the same time transmits into the peer-to-peer network a common bitcoin transaction 10 which is processed normally without regard to the information exchange between the payor and payee.

However, as the payee's administration software is coupled to the blockchain, the payee can see that the bitcoin payment is properly received at the peer-to-peer network and can respond thereto by transmitting a payment acknowledgement 11 back to the wallet. This payment acknowledgement can server as a receipt and may include much information about the purchase transaction [warranty information, proof of purchase, transaction id, delivery status, refund policy, et cetera].

Finally, the wallet module may further indicate via graphical user interface a message 12 to the user which indicates the transaction was completed normally and is now complete.

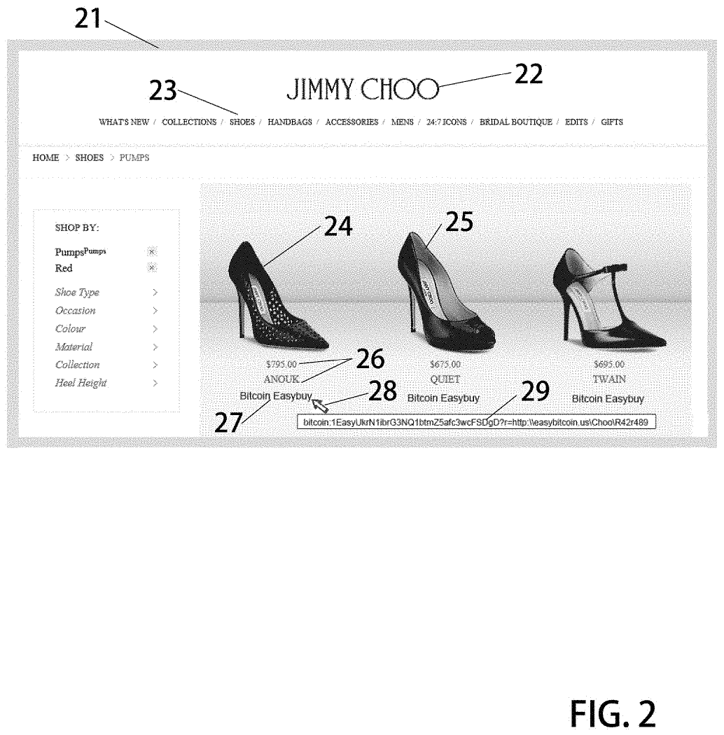

FIG. 2 is directed to an example e-commerce website 21 of these systems. A famous luxury product shoe retailer/‘e-tailer’ 22 “Jimmy Choo” includes product categories 23 in a ‘menu bar’ or ‘tabstrip’ type interactive web object from which users may make selections to cause various types of products to be displayed for customer review. A selection of shoes including “ANOUK” 24 and “QUIET” 25 are displayed with images thereof and other product information 26 such as name and price.

A special hyperlink web object 27 is constructed with a text label: “Bitcoin Easybuy”. In addition, this hyperlink object has associated therewith a tooltip type label which causes text to appear in response to a user controlled cursor 28 hovering about the hyperlink. Tooltip window displays the hyperlinks uniform resource identifier URI 29. In this case, it is a special bitcoin URI which includes a URL that points to the location of a Payment Request specification.

A customer user on an appropriately equipped computing platform, i.e. one that has a special bitcoin wallet module which is responsive to the ‘bitcoin:’ URI, and further this wallet module having a special user profile unit may click the hyperlink to cause her browser to stimulate the wallet module to send a web request to the e-commerce server such that the Payment Request specification may be sent from the e-commerce server to the user. With information contained in the e-commerce website's Payment Request specification, the consumer user's wallet module may form a “Payment” response to be transmitted to the e-commerce website.

Of particular importance for this invention, an e-commerce website includes a Payment Request specification that defines how user shipping information should be arranged and expressed in a Payment response.

An example of one such Payment Request specification is presented herefollowing. In this example, an e-commerce website defines how a customer user's wallet module should formulate shipping information to be received by the retailer such that shipping may be automated.

***Begin Payment Request specification

```
  //
  // Payment Request
  message Output {
```

optional uint64 amount = 1 [default = 0];
required bytes script = 2;

```
  }
  message PaymentDetails {
```

optional string network = 1;
repeated Output outputs = 2;
required uint64 time = 3;
optional uint64 expires = 4;
optional string memo = 5;
optional string payment_url = 6;
optional bytes merchant_data = 7;

```
  }
  message PaymentRequest {
```

optional uint32 payment_details_version = 1;
optional string pki_type = 2 [default = “none”];
optional bytes pki_data = 3;
required bytes serialized_payment_details = 4;
optional bytes signature = 5;

```
  }
  message ShippingDetails {
```

optional boolean do_ship = 1;
optional string ship_service_type = 2 [default = “ground”];
required string recipient = 3;
required string address_line1
optional string address_line2 = 5;
required string city = 6;
required string state = 7;
required string zip = 8;
optional string country = 9;

```
  }
  message X509Certificates {
```

repeated bytes certificate = 1;

```
  }
  message Payment {
```

optional bytes merchant_data = 1;
repeated bytes transactions = 2;

PaymentDetails.outputs

repeated Output refund_to = 3;
optional string memo = 4;

}
message PaymentACK {

required Payment payment = 1;
optional string memo = 2;

}

***End Payment Request specification

In this Payment Request specification, the e-commerce website is defining the specific information elements and data types it requires to effect an automated shipping feature.

In common e-commerce check out systems, a user must enter in a plurality of textbox type date entry web objects shipping information. While this is not overly burdensome on the first few occasions that a user must complete such checkouts, long time web shoppers will tell you that they are fatigued with having to repeatedly enter such information which is quite redundant after having done same or similar more than 10 times. As such, since computers are particularly useful for obviating repetitive actions, these systems are specifically directed to store a user's shipping information and preferences in a profile unit of the wallet module. So entered once, a user can rely upon the wallet to interact with the received Payment Request specification to provide the e-commerce site detailed shipping instructions on the user's behalf without the user having to enter anything at all.

When a wallet receives the Payment Request (or one similar) described above, the wallet detects the presence of the Shipping Details message and responds by recalling user shipping information from the preprogrammed profile portion of the wallet system. Thus, a prescribed user profile portion of the wallet module is used to indicate to e-commerce sites how and where shipping should be effected.

When a consumer user interacts with an e-commerce website via her specially prepared wallet, she responds to bitcoin Payment Request specifications by preparing a Payment response which includes her shipping address and shipping preferences. These are sent in the Payee prescribed format as part of the Payment which is a response to the Payment request.

In this way, a consumer user effects both essential elements of the checkout process in a single efficient step. Payment and shipping information are conveyed to the e-commerce site in one smooth simple action all stimulated by a simple user click on an ‘OK’ authorization step.

For better clarity with regard to the structure of these commerce systems, the reader will note that the primary components include a computing platform for each the payee and payor and these computing platforms are communicatively coupled preferably via http and the Internet (TCP-IP). Still further, each of these computing platforms are additionally in communication with a peer-to-peer cryptocurrency network such as bitcoin. While the bitcoin network is the leading cryptocurrency today, it is fully anticipated that bitcoin will meet its end and a new similar cryptocurrency will rise in its place. In that instance, this teaching will perfectly transfer to the new cryptocurrency system so long as a similar protocol for payments is adopted in the new alternative cryptocurrency.

In particular, a payor computing platform 31 is connected to and communicates with other parties entities via the Internet. A payee computing platform 32 may include as a primary component thereof a e-commerce website 33. In addition, this computing platform may have an administrative component, a warehouse, fulfillment and shipping component, among others.

The e-commerce websites first taught herein include very special hyperlink web objects 34 or devices purposefully arranged, configured and directed to interact in a special manner with customer cryptocurrency wallets. In particular, these hyperlinks may include user readable text labels which suggest purchasing with accompanied automated shipping functionality to inform the user of its superior performance thus allowing the user to more effectively deploy its functionality. For example, “Bitcoin Easybuy” reminds a user that she will not need to enter any shipping information as her preprogrammed user profile will automatically interact with the e-commerce site to provide that on her behalf in the background.

A hyperlink of these systems further comprises a uniform resource identifier. For these systems, it is necessary that the hyperlink use the “bitcoin:” URI. This indicates to a bitcoin wallet module running on a user machine that it shall process the information contained in the URI. A click action on such hyperlink stimulates the wallet module to take an action.

Further, the uniform resource identifier may comprise a uniform resource locator or web address. This web address indicates to the cryptocurrency wallet module 35 the location of a Payment Request specification 36. Thus, the wallet can form a web request action to call the e-commerce website and receive in response thereto the detailed Payment Request file. The e-commerce website then transmits this serializing data structure which includes shipping definitions in the form of data elements and corresponding date type specifications. These are preferably transmitted as XML or protocol buffer short serial data files.

Finally, a hyperlink may additionally include a tooltip with instructions directing a user as to use of the automated shipping feature which is useful in scenaria where the user is unfamiliar with the function and nature of these specially programmed hyperlinks.

Upon receipt of the Payment Request specification from the e-commerce website (or other related administrative site), the appropriately preprogrammed wallet module having a user profile unit 38 with stored data therein relating to a preferred shipping address set by the consumer user, the wallet is fully in position to form a Payment action in accordance with BIP 0070 and transmit that communication to the e-commerce website or payee computing platform which might be arranged as part of a fulfillment center or shipping warehouse. As part of the complete response, the payor's wallet module also prepares and transmits a bitcoin transaction into the peer-to-peer cryptocurrency network 39 for processing there. The payor computing platform can then optionally provide any receipt, acknowledgment or other confirming response to the payor's wallet which can relay that to other coupled systems such as a printer.

One will now fully appreciate how commerce systems based upon cryptocurrency transactions having delivery address information associated therewith may be used to facilitate retail sale/purchase transactions. Although the present invention has been described in considerable detail with clear and concise language and with reference to certain preferred versions thereof including best modes anticipated by the inventors, other versions are possible. Therefore, the spirit and scope of the invention should not be limited by the description of the preferred versions contained therein, but rather by the claims appended hereto.

It is claimed:

1. A method of effecting a payment transaction comprising:
accessing from one or more memory devices computer-readable instructions, wherein the computer-readable instructions are executable by one or more processors of a computing device to:
convey a payment specification to said e-commerce website;
receive a payment request specification from an e-commerce website;
initiate an e-commerce check out action; and
transmit a cryptocurrency transaction into a peer-to-peer cryptocurrency network.

2. The method of claim 1, the computer-readable instructions further executable by the one or more processors to initiate the e-commerce check action that includes stimulating a hyperlink object in a graphical user interface of an e-commerce website, the hyperlink including a bitcoin type uniform resource identifier of the form bitcoin:[string] where [string] includes a uniform resource locator specification.

3. The method of claim 1, wherein the payment request specification includes a shipping address data type.

4. The method of claim 1, wherein the payment specification includes values which specify a particular user shipping address.

5. A commerce system, comprising:
a payor computing device;
a payee computing device; and
a cryptocurrency peer-to-peer network communicatively coupling the payor computing device and the payee computing device,
the payor computing device to comprise a cryptocurrency wallet module having a user profile memory unit; and
the payee computing platform to comprise an e-commerce website, the e-commerce website including at least one hyperlink object having a bitcoin type uniform resource identifier, the bitcoin uniform resource identifier further including a uniform resource locator.

6. The commerce system of claim 5, the user profile memory unit to comprise shipping preferences.

7. The commerce system of claim 5, the uniform resource locator to specify the Internet address of a Payment Request conformance with BEP 0070.13.

8. The commerce system of claim 5, the e-commerce website further to include a Payment Request specification which sets forth a data structure for shipping information.

9. The commerce system of claim 8, the payment request specification to include a dataset characterized as a serializing data structure.

10. The commerce system of claim 9, the serializing data structure to be characterized as protocol buffers.

11. The commerce system of claim 9, the serializing data structure is characterized as XML.

12. The commerce system of claim 9, the data structure to include data elements which set forth shipping address and preferences.
